(19) United States
(12) Patent Application Publication
(10) Pub. No.: US 2022/0343299 A1
(43) Pub. Date: Oct. 27, 2022

(54) Graphical User Interface for Releasing Payments

(71) Applicant: Bottomline Technologies, Inc., Portsmouth, NH (US)

(72) Inventors: Seona Standard, Needham, MA (US); Wali Barrett, Marietta, GA (US)

(73) Assignee: Bottomline Technologies, Inc., Portsmouth, NH (US)

(21) Appl. No.: 17/240,109

(22) Filed: Apr. 26, 2021

(51) Int. Cl. G06Q 20/10; G06F 3/0482; G06F 3/0484; G06F 3/0488

(52) U.S. Cl. CPC G06Q 20/10; G06F 3/0482; G06F 3/0484; G06F 3/0488

(57) ABSTRACT

Disclosed is a method and a system for processing electronic transactions is provided. The system includes an interactive display for displaying a graphical user interface, one or more processing units, and a memory unit for storing one or more programs configured to be executed by the one or more processing units. The graphical user interface includes a top portion and a bottom portion. The one or more programs includes instructions for highlighting an up-arrow on the bottom portion of the graphic user interface demanding to be swipe-up; generating a colored-wave on receiving an interaction through the interactive display; returning the colored-wave back to create the highlighted up-arrow; generating the colored-wave simultaneous to processing of the electronic transaction on receiving a swipe-up; and filling up the graphical user interface completely with the color to indicate the completion of the electronic transaction.

### BACKGROUND OF THE INVENTIONS

### 1. Field of the Inventions

The present inventions generally relate to a graphical user interface for releasing payments, and more particularly relates to a method and a system for providing an interactive graphical user interface for performing electronic transactions.

### 2. Description of Related Art

Recently, portable apparatuses provide not only call and data transmission services but also various services and functions including mobile payment. For example, a user may use a mobile device to make purchases and facilitate payments. In today's internet commerce, many payment transactions are made online via the internet.

The sale and purchase of goods and services between businesses results in the creation of accounts receivable and accounts payable for the creditor (“seller”) and the debtor (“buyer”), respectively. Traditionally, these accounts are maintained separately by the creditor and debtor, and are settled by payment of the outstanding obligation from debtor to creditor using checks, cash, clearing house transfers or wire transfers.

There is a need in the industry to streamline invoice payments from business standards. Therefore, there is a need of a method and a system for providing an interactive graphical user interface for performing electronic transactions that streamlines invoice payments. Further, the method and the system should give an additional time to a sender.

### SUMMARY OF THE INVENTIONS

In accordance with teachings of the present inventions, a method and a system for processing electronic transactions is provided.

An object of the present inventions is to provide a system with an interactive display for displaying a graphical user interface, one or more processing units, and a memory unit for storing one or more programs configured to be executed by the one or more processors.

The graphical user interface includes a top portion and a bottom portion. The one or more programs includes instructions for highlighting an up-arrow on the bottom portion of the graphic user interface demanding to be swipe-up in order to process the electronic transaction.

Further, the one or more programs includes for generating a colored-wave from the bottom portion of the graphical user interface towards the top portion of the graphical user interface on receiving the interaction through the interactive display; returning the colored-wave back to create the highlighted up-arrow demanding to be swipe up in order to process the electronic transaction.

Further, the one or more programs includes the steps of generating the colored-wave from the bottom portion of the graphical user interface towards the top portion simultaneous to processing of the electronic transaction on receiving a swipe-up on the highlighted arrow through the interactive display; and filling up the graphical user interface completely with the color to indicate the completion of the electronic transaction.

Another object of the present inventions is to provide the system wherein the instructions further includes a step of providing a cancel button to cancel the electronic transaction, a step of receiving details of an originator of the electronic transaction, and receiving details of a receiver of the electronic transaction.

Another object of the present inventions is to provide the system wherein the instructions further includes a step of receiving invoices from the receiver of the electronic transaction, a step of clearing bulk invoices by adding invoice amount of the same receiver, and a step of sending an electronic communication to the receiver to confirm about completion of the electronic transaction.

Another object of the present inventions is to provide the system wherein the instructions further includes a step of clearing bulk invoices of different receivers in a single electronic transaction, and providing a summary of the invoices on the graphical user interface for allowing the originator to review the invoices before processing.

Another object of the present inventions is to provide the system wherein the received interaction is either a swipe or touch or a gesture. Further, the instructions include a step of either deleting or rejecting the invoice before processing the electronic transaction.

While a number of features are described herein with respect to embodiments of the inventions; features described with respect to a given embodiment also may be employed in connection with other embodiments. The following description and the annexed drawings set forth certain illustrative embodiments of the inventions. These embodiments are indicative, however, of but a few of the various ways in which the principles of the inventions may be employed. Other objects, advantages, and novel features according to aspects of the inventions will become apparent from the following detailed description when considered in conjunction with the drawings.

### BRIEF DESCRIPTION OF THE DRAWINGS

The annexed drawings, which are not necessarily to scale, show various aspects of the inventions in which similar reference numerals are used to indicate the same or similar parts in the various views.

FIG. 1 illustrates a block diagram of a system for processing electronic transactions;

FIG. 2 illustrates a screenshot showing of a highlighted up-arrow on the graphical user interface;

FIG. 3 illustrates a screenshot showing of a colored-wave on the graphical user interface;

FIG. 4 illustrates a screenshot showing of a semi-filled graphical user interface; and

FIG. 5 illustrates a screenshot showing of completely filled graphical user interface with a cancel button.

### DETAILED DESCRIPTION OF DRAWINGS

The present disclosure is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

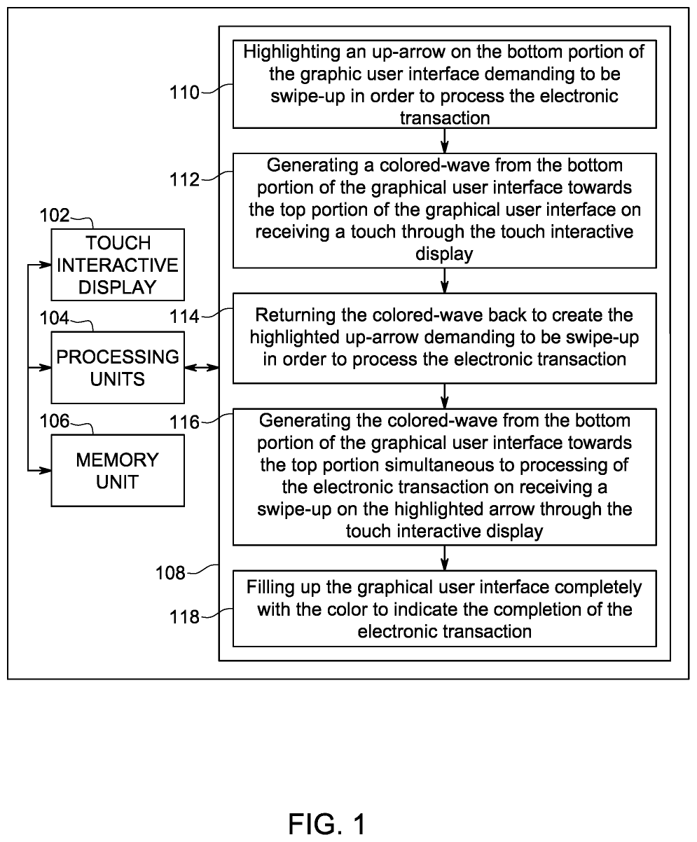

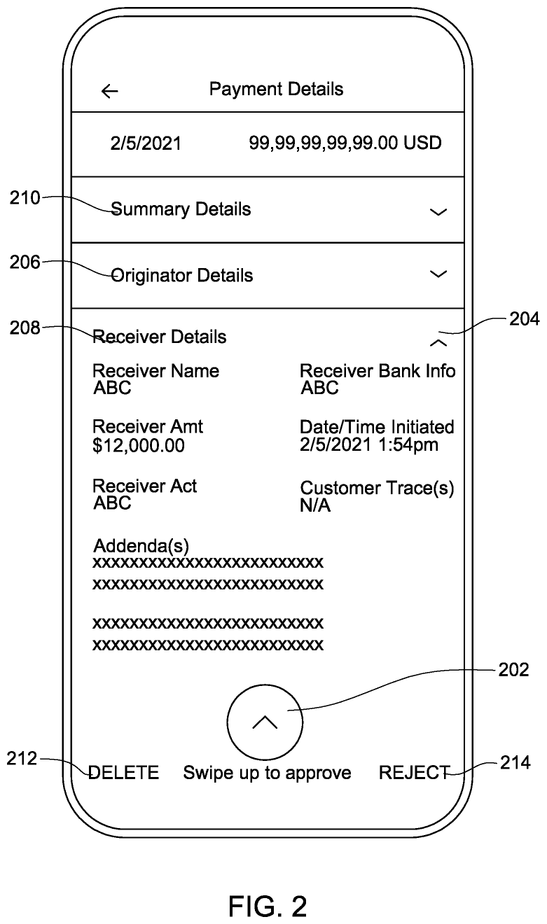

FIG. 1 illustrates a block diagram of a system 100 for processing electronic transactions. The system 100 includes an interactive display 102, one or more processing units 104, and a memory unit 106. The interactive display 102 displays a graphical user interface. The graphical user interface includes a top portion and a bottom portion. The graphical user interface is explained in detail in conjunction with FIG. 2 to FIG. 5 of the present inventions.

The memory unit 106 stores one or more programs configured to be executed by the one or more processors. The one or more programs includes instructions 108. The instructions comprising a step 110 of highlighting an up-arrow on the bottom portion of the graphic user interface demanding to be swipe-up in order to process the electronic transaction. The step 110 is shown in detailed in conjunction with FIG. 2 to FIG. 5 of the present inventions.

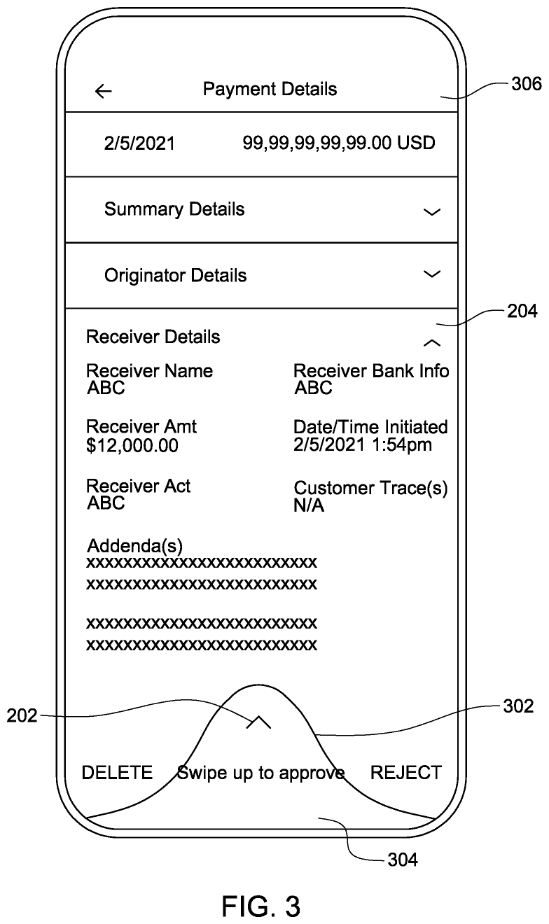

The step 110 is followed by a step 112 of generating a colored-wave from the bottom portion of the graphical user interface towards the top portion of the graphical user interface on receiving an interaction through the interactive display on the highlighted up-arrow. The step 112 is shown in detailed in conjunction with FIG. 3 of the present inventions.

The step 112 is then followed by a step 114 of returning the colored-wave back to create the highlighted up-arrow demanding to be swipe-up in order to process the electronic transaction. Further, the step 114 is then followed by a step 116 of generating the colored-wave from the bottom portion of the graphical user interface towards the top portion simultaneous to processing of the electronic transaction on receiving a swipe-up on the highlighted arrow through the interactive display.

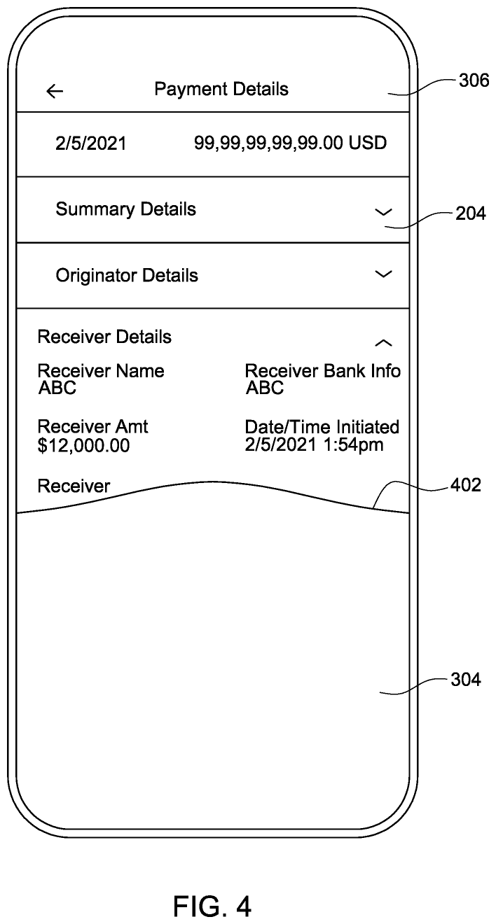

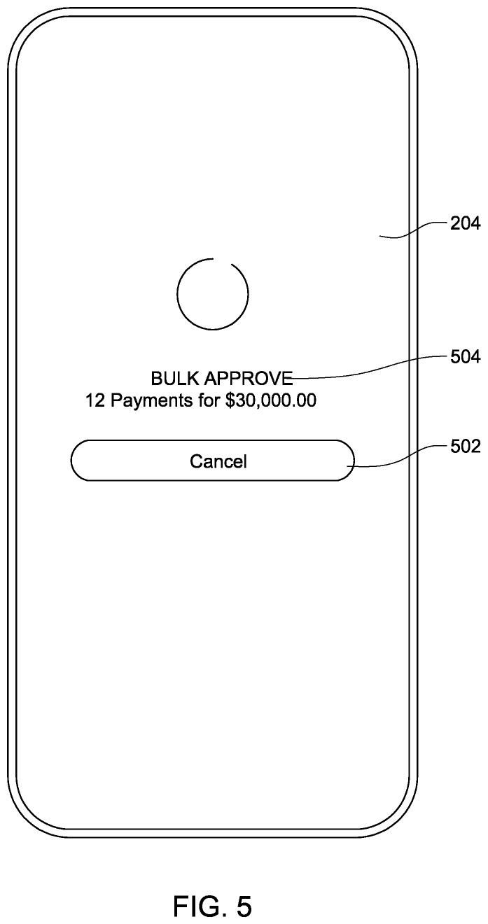

The step 116 is then followed by a step 118 of filling up the graphical user interface completely with the color to indicate the completion of the electronic transaction. The step 116 and the step 118 is shown in detailed in conjunction with FIG. 4, and FIG. 5 respectively of the present inventions.

FIG. 2 illustrates a screenshot showing of a highlighted up-arrow 202 on the graphical user interface 204. In an exemplary embodiment of the present invention, the highlighted up-arrow 202 is shown inside a circle to enhance the appearance of the up-arrow 202. It would be readily apparent to those skilled in the art that various shapes and sizes of up-arrow 202 may be envisioned without deviating from the scope of the present inventions.

Further, it would be readily apparent those skilled in the art that various highlight options such as creating rectangle, square, pentagon, hexagon etc. may be envisioned without deviating from the scope of the present invention. Furthermore, it would be readily apparent to those skilled in the art the up-arrow 202 may be highlighted using various animations such as twinkling, appear, fade, fly in, float in, split, wipe, shape etc.

In another embodiment of the present inventions, the instructions (108, shown in FIG. 1) includes a step of receiving details of an originator 206 of the electronic transaction. Examples of the originator details include but not limited to a name, bank details for sending transaction, address etc.

In another embodiment of the present inventions, the instructions (108, shown in FIG. 1) includes a step of receiving details of a receiver 208 of the electronic transaction. Examples of the receiver details include but not limited to a name, bank details for receiving transaction, address etc.

In another embodiment of the present inventions, the instructions (108, shown in FIG. 1) includes a step of receiving invoices from the receiver of the electronic transaction. The invoices contain the amount to be paid to the receiver by the originator. The user verifies the invoice and releases the payments by swiping the up-arrow 202. Examples of the interaction include but not limited to a swipe, touch, gesture or by any other interaction communication.

In another embodiment of the present inventions, the instructions further include a step of providing a summary 210 of the invoices on the graphical user interface for allowing the originator to review the invoices before processing. The summary 210 provides a list of all invoices that the user is about to process. The user is able to either approve, delete or reject the invoices.

The instructions further include a step of either deleting 212 or rejecting 214 the invoice before processing the electronic transaction. The delete button 212 allows the user to delete all additional or paid invoices. Further, the reject button 214 allows the user to reject the invoices which are surplus, incorrect etc.

Further in another embodiment of the present inventions, the instructions (108, shown in FIG. 1) further includes a step of clearing bulk invoices by adding invoice amount of the same receiver. In order to release bulk invoices of the same receiver, the user is able to add them together and is able to release all invoices in one go. The clearance of bulk invoices in shown and explained in FIG. 5 of the present invention.

FIG. 3 illustrates a screenshot showing of a colored-wave 302 on the graphical user interface 204. The colored-wave 302 is generated from the bottom portion 304 of the graphical user interface towards the top portion 306 of the graphical user interface on receiving an interaction through the interactive display.

It would be readily apparent to those skilled in the art that various color and shapes of the colored-wave 302 may be envisioned without generating from the scope of the present invention. Further, the colored-wave 302 is returned to create the highlighted up-arrow 202 in the bottom portion 304 demanding to be swipe-up in order to process the electronic transaction. This effect brings attention to the user to swipe-up the arrow 202 to initiate the electronic transaction.

Those skilled in the art may envision alternate embodiments such as the arrow placed at the top portion of the graphical user interface and the user is asked to swipe down resulting in the colored-wave 302 moving down rather than up, without deviating from the scope of the present invention.

FIG. 4 illustrates a screenshot showing of a semi-filled graphical user interface 204. The graphical user interface 204 starts to fill in as the colored-wave 402 generates from the bottom portion 304 of the graphical user interface towards the top portion 306 simultaneous to processing of the electronic transaction on receiving a swipe-up on the highlighted up-arrow through the interactive display. In exemplary embodiment as shown in FIG. 4, the graphical user interface is partially filled to showcase that the transaction is process.

FIG. 5 illustrates a screenshot showing of completely filled graphical user interface 204 with a cancel button 502. The payments are processed and thus the graphical user interface 204 is completely filled up. The complete filling up of the graphical user interface 204 indicates the completion of the electronic transaction.

Further in another embodiment, the instructions further include a step of providing a cancel button 504 for a pre-defined time to permit a user to have sufficient time to cancel the processed electronic transaction. The cancel button 502 gives an additional time to reverse the transactions in case of any fault in releasing the payments. It would be readily apparent to those skilled in the art that various pre-defined time may be envisioned without deviating from the scope of the present invention.

Further in exemplary embodiment of the present invention as shown in FIG. 5, the electronic transaction is for bulk invoices. For example, the total invoices are 12 and for a total payment of USD 30,000, which are bulk approved 504. It would be readily apparent to those skilled in the art that various number of invoices may be cleared together without deviating from the scope of the present invention.

It should be appreciated that many of the elements discussed in this specification may be implemented in a hardware circuit(s), a circuitry executing software code or instructions which are encoded within computer readable media accessible to the circuitry, or a combination of a hardware circuit(s) and a circuitry or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a circuitry or control block executing code encoded in a computer readable media, or a combination of a hardware circuit(s) and a circuitry and/or control block executing such code.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the inventions have been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the inventions. In addition, while a particular feature of the inventions may have been described above with respect to only one or more of several illustrated embodiments, such feature may be combined with one or more other features of the other embodiments, as may be desired and advantageous for any given or particular application.

1. A system for processing electronic transactions, the system comprising:
an interactive display for displaying a graphical user interface, wherein the graphical user interface having a top portion and a bottom portion;
one or more processing units; and
a memory unit for storing one or more programs configured to be executed by the one or more processing units, the one or more programs including instructions for:
highlighting an up-arrow on the bottom portion of the graphic user interface demanding to be swiped-up in order to process the electronic transaction;
generating a colored-wave from the bottom portion of the graphical user interface towards the top portion of the graphical user interface on receiving an interaction through the interactive display on the highlighted up-arrow;
returning the colored-wave back to create the highlighted up-arrow demanding to be swiped-up in order to process the electronic transaction;
generating the colored-wave from the bottom portion of the graphical user interface towards the top portion simultaneous to processing of the electronic transaction on receiving a swipe-up on the highlighted up-arrow through the interactive display, said color-wave display creating a delay; and
filling up the graphical user interface completely with the color to indicate the completion of the electronic transaction.

2. The system according to claim 1 wherein the instructions further comprising a step of providing a cancel button for a pre-defined time to cancel the processed electronic transaction.

3. The system according to claim 1 wherein the instructions further comprising a step of receiving details of an originator of the electronic transaction.

4. The system according to claim 1 wherein the instructions further comprising a step of receiving details of a receiver of the electronic transaction.

5. The system according to claim 4 wherein the instructions further comprising a step of receiving invoices from the receiver of the electronic transaction.

6. The system according to claim 5 wherein the instructions further comprising a step of clearing bulk invoices by adding invoice amount of the receiver.

7. The system according to claim 4 wherein the instructions further comprising a step of sending an electronic communication to the receiver to confirm about completion of the electronic transaction.

8. The system according to claim 4 wherein the instructions further comprising a step of clearing bulk invoices of different receivers in a single electronic transaction.

9. The system according to claim 8 wherein the instructions further comprising a step of providing a summary of the invoices on the graphical user interface for allowing an originator to review the invoices before the processing.

10. The system according to claim 1 wherein the received interaction is at least one of: a swipe; touch; and a gesture.

11. The system according to claim 9 wherein the instructions further comprising a step of either deleting or rejecting the invoice before processing the electronic transaction.

12. A computer-implemented method for providing an improved graphical user interface (GUI) from one or more processing units to process an electronic transaction, the method comprising:
highlighting an up-arrow on a bottom portion of the graphic user interface demanding to be swiped-up in order to process the electronic transaction;
generating a colored-wave from the bottom portion of the graphical user interface towards a top portion of the graphical user interface on receiving an interaction through an interactive display on the highlighted up-arrow;
returning the colored-wave back to create the highlighted up-arrow demanding to be swiped-up in order to process the electronic transaction;
generating the colored-wave from the bottom portion of the graphical user interface towards the top portion simultaneous to processing of the electronic transaction on receiving a swipe-up on the highlighted arrow through the interactive display, said color-wave display creating a delay; and
filling up the graphical user interface completely with the color to indicate the completion of the electronic transaction.

13. The computer-implemented method according to claim 12 wherein the method comprising a step of providing a cancel button for a pre-defined time to cancel the processed electronic transaction.

14. The computer-implemented method according to claim 12 wherein the method comprising a step of receiving details of an originator of the electronic transaction; receiving details of a receiver of the electronic transaction; and receiving invoices from the receiver of the electronic transaction.

15. The computer-implemented method according to claim 14 wherein the method comprising a step of clearing bulk invoices by adding invoice amount of the receiver; and a step of clearing the bulk invoices of different receivers in a single electronic transaction.

16. The computer-implemented method according to claim 12 wherein the method comprising a step of sending an electronic communication to the receiver to confirm about completion of the electronic transaction.

17. The computer-implemented method according to claim 14 wherein the method comprising a step of providing a summary of the invoices on the graphical user interface for allowing the originator to review the invoices before the processing.

18. The computer-implemented method according to claim 17 wherein the method comprising a step of either deleting or rejecting the invoice before processing the electronic transaction.

19. The computer-implemented method according to claim 12 wherein received interaction is at least one of: a swipe; a touch; and a gesture.
